(19) United States
(12) Patent Application Publication
(10) Pub. No.: US 2018/0144331 A1
(43) Pub. Date: May 24, 2018

(54) INFORMATION PROCESSING APPARATUS AND INFORMATION PROCESSING METHOD

(71) Applicant: TOSHIBA TEC KABUSHIKI KAISHA, Tokyo (JP)

(72) Inventor: Shigehiro EDASAWA, Gotenba Shizuoka (JP)

(21) Appl. No.: 15/815,016

(22) Filed: Nov. 16, 2017

(30) Foreign Application Priority Data
Nov. 22, 2016 (JP) 2016-226967

(51) Int. Cl. G06Q 20/20; G06F 21/31; G06F 21/62

(52) U.S. Cl. CPC G06Q 20/206; G06F 21/62; G06F 21/31

(57) ABSTRACT

According to an embodiment, an information processing apparatus includes a communication interface, a memory device, and a controller. The controller inputs an authentication request from an information processing terminal via the communication interface. The controller determines that the user is a special user on a basis of identifier information identifying a user in the authentication request and the identifier information of the special user preregistered in the memory device. Where a department to which the determined special user belongs is different from a department to which the information processing terminal belongs, the controller changes the authority information of the special user stored in the memory device into authority information including lower authority rank.

### CROSS-REFERENCE TO RELATED APPLICATIONS

This application is based upon and claims the benefit of priority from the prior Japanese Patent Application No. 2016-226967, filed on Nov. 22, 2016, the entire contents of which are incorporated herein by reference.

### FIELD

An embodiment to be described here generally relates to an information processing apparatus and an information processing method.

### BACKGROUND

As information processing apparatuses, for example, product selling and registering processing apparatuses such as a terminal apparatus of a POS (Point Of Sales) system (point of sales information management system) used in a retail store and an ECR (Electronic Cash Register) are known. Use (operation) of such a product selling and registering processing apparatus is restricted such that only a person, who is allowed to use (operate) the apparatus, can use (operate) the apparatus. Further, in general, the scope of work (scope of information processing) of operating the apparatus is determined on the basis of personal information such as an organization and a license of a person, who is allowed to use (operate) the apparatus. In other words, the scope of work for operating the apparatus is also restricted depending on a group (or may be referred to as “authority group”, “authority rank”, or the like) to which an apparatus user (operator) belongs. Because of this, before operating (using) the apparatus, a person who operates (uses) the apparatus inputs a preassigned private unique code (identifier information) (sometimes simply referred to as “sign-on”, “sign-in”, “log-on”, “log-in”, or the like). Further, the apparatus specifies the group to which the user (operator) belongs on a basis of the input code, and accepts use and operation within the permitted scope of authority of the group.

By the way, where a employer runs a plurality of retail stores, if the number of store-workers working for one store is not enough, a person who usually works for a store different from that store, may temporarily work for that store. As described above, the store-worker, who temporarily works for that different store, is in fact a store-worker working for the same retail store group. So the store-worker is able to use and operate a product selling and registering processing apparatus at that store, for which the store-worker temporarily works, as if it is an apparatus at the store, for which the store-worker usually works. However, it is not preferable that a store-worker, who does not usually work for that store, is capable of operating and using a product selling and registering processing apparatus, which is used at that store, just the same as store-workers, who usually work for that store. It is desirable to improve that.

### BRIEF DESCRIPTION OF THE DRAWINGS

FIG. 1 is a diagram illustrating an example of the POS system of an embodiment.

FIG. 2 is a block diagram showing an example of a hardware configuration of the headquarter server of the present embodiment.

FIG. 3 is a diagram illustrating an example of the worker master data of the present embodiment.

FIG. 4 is a block diagram showing an example of a hardware configuration of the store server of the present embodiment.

FIG. 5 is a block diagram showing an example of a hardware configuration of the POS terminal of the present embodiment.

FIG. 6 is a diagram illustrating an example of the execution authority master data of the present embodiment.

FIG. 7 is a block diagram showing characteristic functional configurations of the apparatuses of the POS system of the present embodiment.

FIG. 8 is a flowchart showing an example of an executing and determining process of the present embodiment.

FIG. 9 is a flowchart showing an example of a sign-on process of the present embodiment.

FIG. 10 is a flowchart showing an example of a worker determining process of the present embodiment.

### DETAILED DESCRIPTION

According to an embodiment, an information processing apparatus manages an information processing terminal, the information processing terminal belonging to a predetermined department and being configured to execute a plurality of functions. The information processing apparatus includes a communication interface, a memory device, and a controller. The communication interface is configured to communicate with the information processing terminal and a different information processing apparatus. The memory device stores master data of a special user, use of the information processing terminal being permitted for the special user, the master data including identifier information identifying the special user and authority information preregistered in association with each other, the authority information indicating authority of execution of the plurality of functions of the information processing terminal. The controller is configured to input an authentication request for a user from the information processing terminal via the communication interface, the authentication request including identifier information identifying a user who wishes to use the information processing terminal. The controller is configured to determine that the user identified by the identifier information in the authentication request is the special user on a basis of the identifier information in the authentication request and the identifier information registered in the master data of the special user. The controller is configured to obtain the authority information of the determined special user from the master data of the special user. The controller is configured to, where a department to which the determined special user belongs is different from a department to which the information processing terminal belongs, in order to restrict execution of a partial function/partial functions out of executable functions of the information processing terminal, the executable functions being executable based on authority indicated by the obtained authority information, change the obtained authority information into authority information indicating a lower authority, and set the changed authority information as authority information of the user identified by the identifier information in the authentication request.

Hereinafter, with reference to the drawings, an information processing apparatus and an information processing method of an embodiment will be described in detail. In the drawings, the same reference symbols indicate the same or similar units. In the following, an information processing apparatus and an information processing method of an embodiment will be described, and configurations, specs, and the like are not limited. According to an application example of the present embodiment, an information processing apparatus and an information processing method are applied to a POS system of a store such as a retail store.

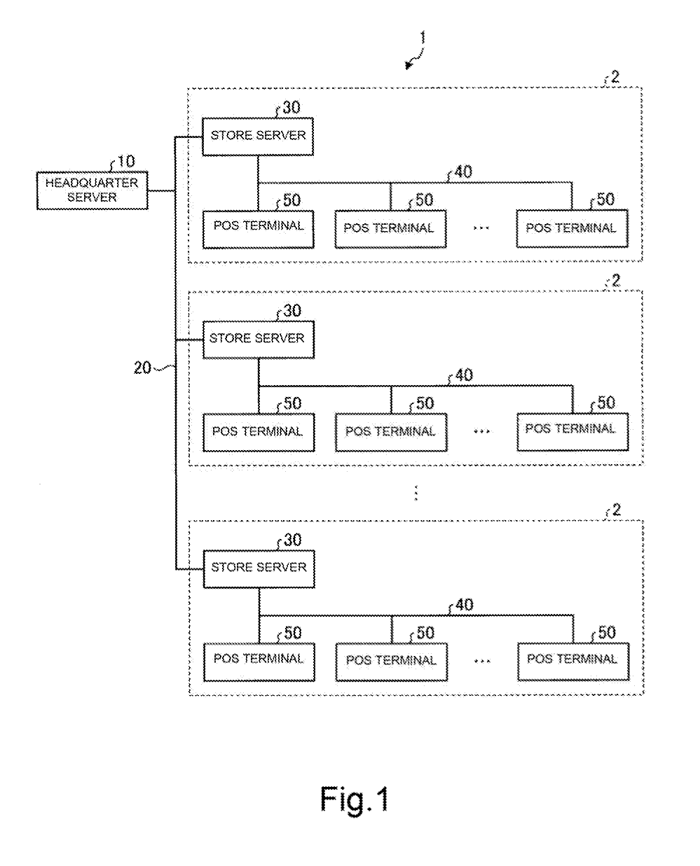

FIG. 1 is a diagram illustrating an example of the POS system 1 of an embodiment. The POS system 1 includes the headquarter server 10. The headquarter server 10 is at the headquarter of a plurality of stores being predetermined departments. The headquarter server 10 manages the plurality of store systems 2. Each store system 2 includes the store server 30 of each store. Each store server 30 manages the POS terminals 50. Each POS terminal 50 executes information processing such as a product selling and registering process at that store. Further, the store server 30 manages a special user such as a worker such as a store-worker who usually works for product selling and registering at that store. Note that, hereinafter, a person who operates (uses) the POS terminal 50 at each store will be referred to as a user. Further, a special user who works at each store may be simply referred to as a worker. Users include workers, and may further include people other than workers.

The headquarter server 10 is, for example, a server type computer. The headquarter server 10 is connected to the store servers 30 via the network 20. Each store server 30 is the core of each store system 2. The headquarter server 10 is capable of communicating and exchanging data with the store systems 2. The headquarter server 10 distributes various information to the store systems 2 of the respective stores. Further, the headquarter server 10 executes the process requested by the store system 2, and returns the result of execution. Further, the headquarter server 10 stores personal information such as accounts of workers and the like. Note that the headquarter server 10 may not necessarily be at the headquarter. The headquarter server 10 may include computer resources such as hardware and software provided by a cloud service provider. Further, the headquarter server 10 may not necessarily be a single computer. The headquarter server 10 may be a distributed system including a plurality of computers. Further, the headquarter server 10 may be a grid computing system or the like including a plurality of computers of a wide network.

The store server 30 is, for example, a computer such as a personal computer and a server apparatus. Further, the store server 30 manages the POS terminals 50 and workers that belong to that store. The store server 30 is capable of communicating with the plurality of POS terminals 50 via the store network 40. The store server 30 distributes various information to the POS terminals 50 that belong to the store system 2. The store server 30 executes the process requested by the POS terminal 50, and returns the result of execution to the POS terminal 50. Further, the store server 30 stores personal information such as accounts of workers who belong to that store. Note that the store server 30 may be provided by a cloud service or the like that provides computer resources such as hardware and software. Further, the store server 30 may include a plurality of server apparatuses and the like.

The POS terminal 50 executes a process of registering sales of sold products (sales registering process), a process of calculating the total price and the like of the sold products (payment process), and the like. Further, the POS terminal 50 has a sign-on function. In other words, the POS terminal 50 permits a user to use the POS terminal 50 on a condition that a sign-on account indicates a preregistered worker. Further, the POS terminal 50 executes a function operated by a user (worker) on a condition that the rank of authority of a worker is the rank (execution authority rank (described later)) of authority determined for each function, or more.

Next, hardware configurations of the various apparatuses of the POS system 1 will be described.

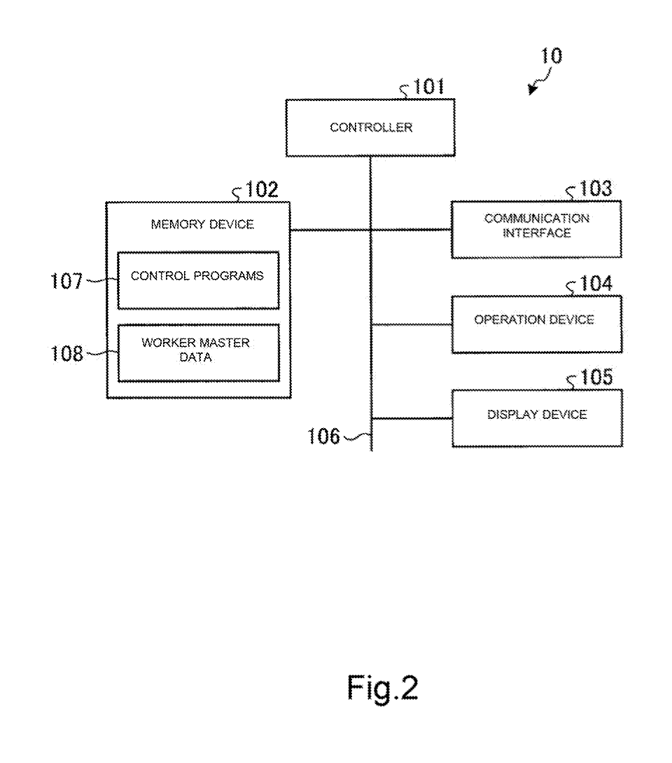

FIG. 2 is a block diagram showing an example of a hardware configuration of the headquarter server 10. The headquarter server 10 includes the controller 101, the memory device 102, the communication interface 103, the operation devices 104, and the display device 105. The controller 101, the memory device 102, the communication interface 103, the operation devices 104, and the display device 105 are connected to each other via the system bus 106 such as a data bus and an address bus.

The controller 101 controls the entire operations of the headquarter server 10, and realizes various functions provided by the headquarter server 10. The controller 101 includes a CPU (Central Processing Unit), a ROM (Read Only Memory), and a RAM (Random Access Memory). The CPU controls the overall operations of the headquarter server 10. The ROM stores various programs and data. The RAM temporarily stores various programs, and rewritably stores various data. The CPU uses the RAM as a work area (working area), and executes programs stored in the ROM, the memory device 102, or the like.

The memory device 102 is a storage device such as an HDD (Hard Disk Drive) and an SSD (Solid State Drive). The memory device 102 stores the control programs 107 and the worker master data 108. The control programs 107 include the operating system, programs that realizes functions provided by the headquarter server 10, and the like. Further, the control programs 107 include a program that realizes the function of the present embodiment.

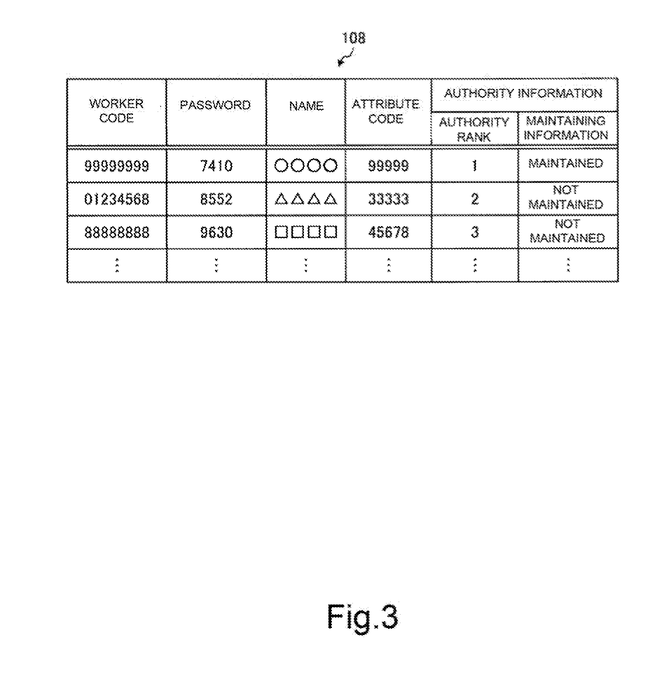

FIG. 3 is a diagram illustrating an example of the worker master data 108. The worker master data 108 includes set information. Personal information of workers employed by an employer, who runs one store or a plurality of stores, is registered in the worker master data 108. The worker master data 108 includes a worker code, a password, a name, an attribute code, and authority information stored in association with each other. A worker code is identifier information capable of identifying each worker. Further, a worker code is also identifier information identifying a user who uses the POS terminal 50. In other words, a worker code is identifier information identifying a user for determining whether the user is a worker or not. A password is information used to authenticate a worker in combination with a worker code. For example, a password is a text including alphabets and numbers. Further, a worker code and a password are used to determine whether a user has an account or not. An account is a right necessary to use a computer and a network, the use of the computer and the network being not open for unspecified persons and restricted for specified persons. Therefore, an account is registered/issued for individual user, and includes identifier information (ID: IDentifier) identifying each user such as an identifier number (for example, worker code, etc.) and an identifier name (user name, account name). Further, an account includes authenticated information for personal identification such as PIN and password. Further, an account includes set information such as authority for each resource. A name is the name or the like of a worker identified by a worker code. An attribute code is identifier information capable of identifying an attribute to which a worker belongs. For example, an attribute code is a store code identifying a store to which a worker belongs. Authority information is information indicating authority of execution of the functions of the POS terminal 50 or the like. Authority information includes authority rank and maintaining information. Authority rank is information indicating a grade (class, group) of authority, which is set graded for a worker. For example, the larger the value of the authority rank than “1”, the lower the authority and the smaller the number of the kinds of executable functions. In short, the higher the value of the authority rank, the lower the level of the rank. Maintaining information is information indicating that authority is not restricted but maintained at a store other than the store to which a worker belongs. In other words, maintaining information is information indicating that to lower an authority rank is avoided, even where the attribute code of a worker is different from the attribute code of a store to which the POS terminal 50 used by the worker belongs.

The communication interface 103 is an interface configured to communicate with the store servers 30 and the like connected to the network 20.

The operation devices 104 include input devices such as a keyboard and a mouse.

The display device 105 is, for example, a liquid crystal display device. Note that the display device 105 may not be a liquid crystal display device but, instead, may be an organic EL display device or the like.

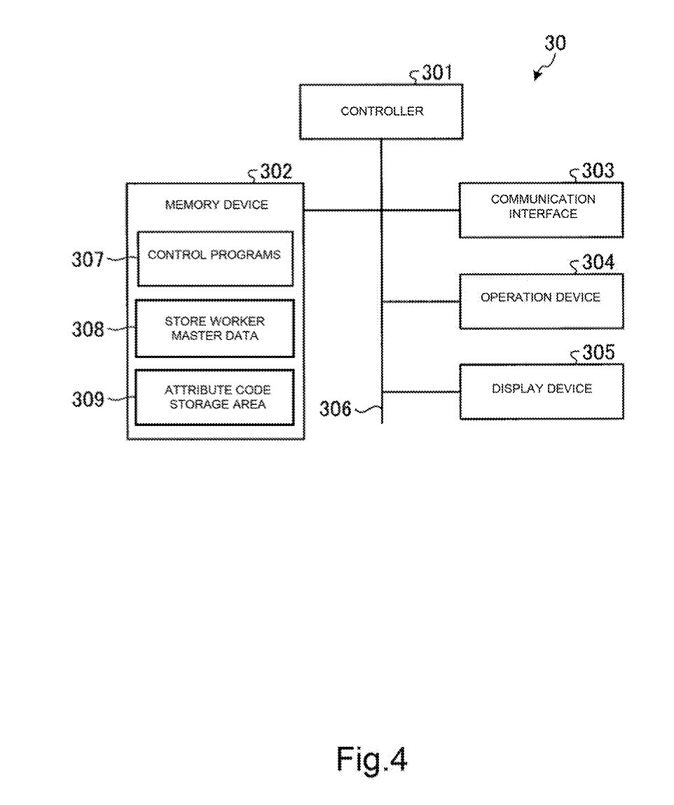

FIG. 4 is a block diagram showing an example of a hardware configuration of the store server 30. The store server 30 includes the controller 301, the memory device 302, the communication interface 303, the operation devices 304, and the display device 305. The controller 301, the memory device 302, the communication interface 303, the operation devices 304, and the display device 305 are connected to each other via the system bus 306 such as a data bus and an address bus.

The controller 301 controls the entire operations of the store server 30, and realizes various functions provided by the store server 30. The controller 301 includes a CPU, a ROM, and a RAM. The CPU controls the overall operations of the store server 30. The ROM stores various programs and data. The RAM temporarily stores various programs, and rewritably stores various data. The CPU uses the RAM as a work area (working area), and executes programs stored in the ROM, the memory device 302, or the like.

The memory device 302 is a storage device such as an HDD and an SSD. The memory device 302 stores the control programs 307 and the store-worker master data 308. The control programs 307 include the operating system, programs that realizes functions provided by the store server 30, and the like. The control programs 307 include a program that realizes the function of the present embodiment.

The store-worker master data 308 is set information. Information (worker codes, passwords, names, attribute codes, and authority information) of the workers, who belong to the store of the store system 2 managed by the store server 30, out of the information of the workers registered in the worker master data 108, is registered in the store-worker master data 308.

Further, the memory device 302 includes the attribute code storage area 309. The attribute code storage area 309 is a storage area that stores the attribute code of the store of the store system 2 managed by the store server 30. In other words, the worker codes of the workers, whose attribute code is the same as the attribute code stored in the attribute code storage area 309, are registered in the store-worker master data 308.

The communication interface 303 is an interface configured to communicate with the headquarter server 10 and the like connected to the network 20. Further, the communication interface 303 is an interface configured to communicate with the POS terminals 50 and the like connected to the store network 40.

The operation devices 304 include input devices such as a keyboard and a mouse.

The display device 305 is, for example, a liquid crystal display device. Note that the display device 305 may not be a liquid crystal display device but, instead, may be an organic EL display device or the like.

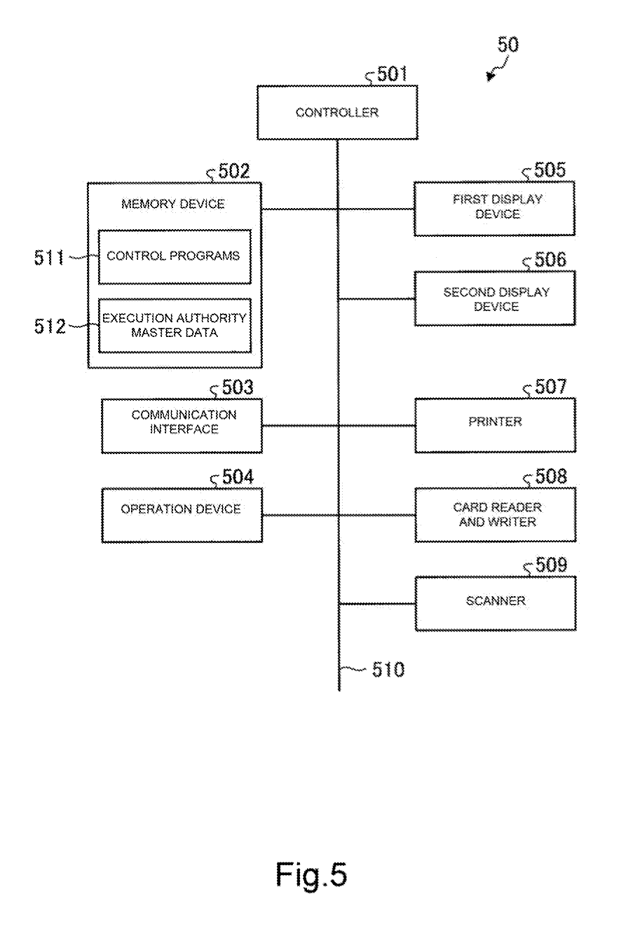

FIG. 5 is a block diagram showing an example of a hardware configuration of the POS terminal 50. The POS terminal 50 includes the controller 501, the memory device 502, the communication interface 503, the operation device 504, the first display device 505, the second display device 506, the printer 507, the card reader and writer 508, and the scanner 509. The controller 501, the memory device 502, the communication interface 503, the operation device 504, the first display device 505, the second display device 506, the printer 507, the card reader and writer 508, and the scanner 509 are connected to each other via the system bus 510 such as a data bus and an address bus.

The controller 501 controls the entire operations of the POS terminal 50, and realizes various functions provided by the POS terminal 50. The controller 501 includes a CPU, a ROM, and a RAM. The CPU controls the overall operations of the POS terminal 50. The ROM stores various programs and data. The RAM temporarily stores various programs, and rewritably stores various data. Further, the CPU uses the RAM as a work area (working area), and executes programs stored in the ROM, the memory device 502, or the like.

The memory device 502 is a storage device such as an HDD and an SSD. The memory device 502 stores the control programs 511 and the execution authority master data 512. The control programs 511 include the operating system, programs that realizes functions provided by the POS terminal 50, and the like. Further, the control programs 511 include a program that realizes the function of the present embodiment. Further, the memory device 502 may store the attribute code of the store system 2 of the store to which the POS terminal 50 belongs.

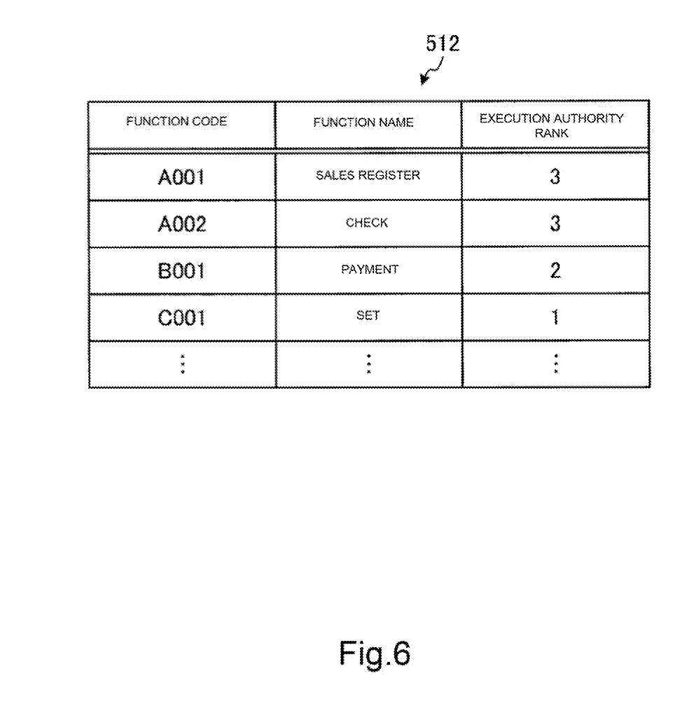

Here, FIG. 6 is a diagram illustrating an example of the execution authority master data 512. The execution authority master data 512 is set information, in which authority rank to which execution of each function is permitted is set for each function of the POS terminal 50. The execution authority master data 512 stores a function code, a function name, and an execution authority rank in association with each other. The function code is identifier information capable of identifying each function. The function name is information indicating the name of each function. The execution authority rank is authority rank of workers, to which execution of the function identified by the function code is permitted. Further, the POS terminal 50 executes a function instructed by a user (worker), on a condition that the authority rank of the sign-on user (worker) is the execution authority rank or higher (equal rank or higher rank). As described above, for example, the larger the value of the authority rank than “1”, the lower the authority and the smaller the number of the kinds of executable functions. Therefore the POS terminal 50 executes a function instructed by a user (worker), where the authority rank “value” of the user (worker) is equal to or less than the execution authority rank “value” of the function instructed by the user (worker).

The communication interface 503 is an interface configured to communicate with the store server 30 and the like connected to the store network 40.

The operation device 504 is an input device such as a keyboard.

The first display device 505 is a liquid crystal display device, a touch panel being layered on its display surface, or the like. The first display device 505 displays various windows for a store-worker of the store, for example. The second display device 506 is a liquid crystal display device, a touch panel being layered on its display surface, or the like. The second display device 506 displays various windows for a customer, for example.

The printer 507 prints receipts and journals.

The card reader and writer 508 is a device configured to read information stored in a storage medium of a card used for payment such as a credit card, and write information in the storage medium of the card.

The scanner 509 optically reads code information from a code symbol such as a barcode on each product that a customer wishes to purchase.

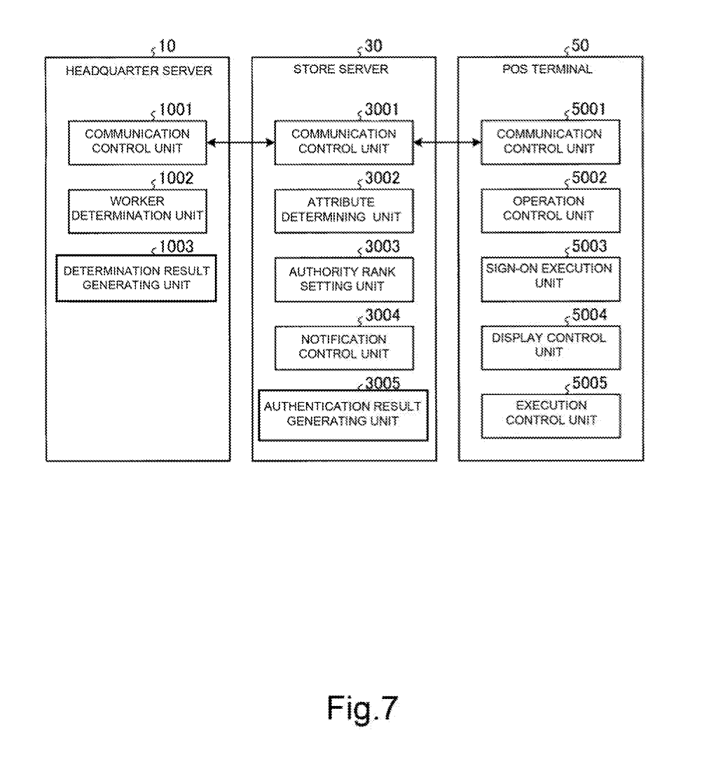

Next, characteristic functions of the apparatuses of the POS system 1 will be described. Here, FIG. 7 is a block diagram showing characteristic functional configurations of the apparatuses of the POS system 1.

The controller 101 of the headquarter server 10 loads the control programs 107 stored in the memory device 102 in the RAM, executes the control programs 107, and thereby generates the respective functional units in the RAM. Specifically, the controller 101 of the headquarter server 10 includes, as functional units, the communication control unit 1001, the worker determining unit 1002, and the determination result generating unit 1003.

The communication control unit 1001 controls the communication interface 103 to communicate with the store servers 30 and the like. For example, the communication control unit 1001 receives a worker determination request from the store server 30. The worker determination request includes a worker code-to-be-determined and a password. The worker code-to-be-determined and the password are the same as the worker code and the password in a sign-on request (described later). The worker determination request is information for requesting to determine whether the user specified by the worker code-to-be-determined is a worker or not. It is determined by determining whether an account, which is in association with the combination of the worker code-to-be-determined and the password, is registered in the worker master data 108 or not. Further, the communication control unit 1001 sends a worker determination result generated by the determination result generating unit 1003 to the store server 30.

In order to respond to the worker determination request, the worker determining unit 1002 determines whether the account of the user, who is specified by the worker code-to-be-determined, is registered in the worker master data 108 or not. Specifically, for example, where the communication control unit 1001 receives a worker determination request, the worker determining unit 1002 extracts a worker code-to-be-determined and a password from the worker determination request. Where the combination of the extracted worker code-to-be-determined and password is registered in the worker master data 108, the worker determining unit 1002 determines that the account of the user specified by the worker code-to-be-determined is registered in the worker master data 108. Meanwhile, where the combination of the extracted worker code-to-be-determined and password is not registered in the worker master data 108, the worker determining unit 1002 determines that the account of the user specified by the worker code-to-be-determined is not registered in the worker master data 108.

The determination result generating unit 1003 generates, as a worker determination result, information to be sent by the communication control unit 1001. Where the worker determining unit 1002 determines that a user specified by the worker code-to-be-determined is not a worker, the determination result generating unit 1003 generates unauthenticated information. The unauthenticated information is information indicating that the worker code-to-be-determined is unauthenticated. Further, the determination result generating unit 1003 causes the communication control unit 1001 to send the unauthenticated information as the worker determination result.

Meanwhile, where the worker determining unit 1002 determines that a user specified by the worker code-to-be-determined is a worker, the determination result generating unit 1003 generates authenticated information. The authenticated information is information indicating that the worker code-to-be-determined is authenticated. Further, the determination result generating unit 1003 extracts the attribute code and the authority information in the account, which is in association with the combination of the worker code-to-be-determined and the password, from the worker master data 108. Further, the determination result generating unit 1003 causes the communication control unit 1001 to send the authenticated information, the attribute code, and the authority information, as a worker determination result.

The controller 301 of the store server 30 loads the control programs 307 stored in the memory device 302 in the RAM, executes the control programs 307, and thereby generates the respective functional units in the RAM. Specifically, the controller 301 of the store server 30 includes, as functional units, the communication control unit 3001, the attribute determining unit 3002, the authority rank setting unit 3003, the notification control unit 3004, and the authentication result generating unit 3005.

The communication control unit 3001 is an example of an input means and an output means. The communication control unit 3001 controls the communication interface 303 to communicate with the POS terminals 50, the headquarter server 10, and the like. For example, the communication control unit 3001 receives, from the POS terminal 50, an authentication request (hereinafter, referred to as sign-on request) for requesting to determine whether sign-on of a user is permitted or not. The sign-on request includes the worker code and the password of a user (worker), who requests to sign on to the POS terminal 50. Further, in response to the authentication request (sign-on request), the communication control unit 3001 sends an authentication result (hereinafter, referred to as sign-on result) to the POS terminal 50. Further, the communication control unit 3001 sends, to the headquarter server 10, the worker determination request for requesting to determine whether the user, who is specified by the worker code in the sign-on request, is a worker or not. Further, the communication control unit 3001 receives the worker determination result from the headquarter server 10.

Where the communication control unit 3001 receives a sign-on request, the attribute determining unit 3002 determines an attribute to which the user (worker), who is specified by the worker code in the sign-on request, belongs. Where an account, which is in association with the combination of the worker code and the password in the sign-on request, is registered in the store-worker master data 308, the attribute determining unit 3002 determines that the user specified by the worker code in the sign-on request is a worker, who belong to the store that has the POS terminal 50-to-be-signed-on. In other words, where the combination of the worker code and the password in the sign-on request is registered in the store-worker master data 308, the attribute determining unit 3002 determines that the user specified by the worker code in the sign-on request is a worker whose account is registered in the store-worker master data 308. Further, the attribute determining unit 3002 determines that the user, who is specified by the worker code in the sign-on request, is a worker who belongs to the store, which is the same as the store having the POS terminal 50-to-be-signed-on. Here, a worker code of a worker, who has the attribute code the same as the attribute code stored in the attribute code storage area 309, is registered in the store-worker master data 308. Therefore, the attribute determining unit 3002 determines whether a worker code in a sign-on request is registered in the store-worker master data 308 or not. As a result, the attribute determining unit 3002 is capable of determining whether an attribute, to which the user specified by the worker code in the sign-on request belongs, is the same as an attribute specified by the attribute code stored in the attribute code storage area 309 or not. In other words, the attribute determining unit 3002 is capable of determining whether the attribute code of the user, who is specified by the worker code in the sign-on request, is the same as the attribute code of the POS terminal 50-to-be-signed-on, or not.

Meanwhile, where an account, which is in association with the combination of the worker code and the password in the sign-on request, is not registered in the store-worker master data 308, the attribute determining unit 3002 causes the communication control unit 3001 to send a worker determination request. By doing so, the attribute determining unit 3002 asks the headquarter server 10 whether an account in association with the combination of the worker code and the password in the sign-on request is registered in the worker master data 108 or not. Where an account in association with the combination of the worker code and the password in the sign-on request is not registered in the store-worker master data 308, and where an account in association with the combination of the worker code and the password in the sign-on request is registered in the worker master data 108, the attribute determining unit 3002 determines that the attribute of the user specified by the worker code in the sign-on request is different from the attribute of the POS terminal 50-to-be-signed-on. In other words, the attribute determining unit 3002 determines that the attribute code, which indicates the attribute to which the worker specified by the worker code in the sign-on request belongs, is different from the attribute code, which indicates the attribute to which the POS terminal 50 belongs. Further, where an account in association with the combination of the worker code and the password in the sign-on request is not registered in the store-worker master data 308 and the worker master data 108, the attribute determining unit 3002 determines that the user, who is specified by the worker code in the sign-on request, is not a worker.

The authority rank setting unit 3003 is an example of an obtaining means and a setting means. The authority rank setting unit 3003 sets authority rank to be assigned to a worker for sign-on. For example, where the attribute determining unit 3002 determines that the user, who is specified by the worker code in the sign-on request, is a worker, who belongs to the store the same as the store having the POS terminal 50-to-be-signed-on, the authority rank setting unit 3003 sets authority rank of the store-worker master data 308. In other words, the authority rank setting unit 3003 obtains the authority information of the worker, who is specified by the worker code in the sign-on request, from the store-worker master data 308. Further, the authority rank setting unit 3003 sets the authority rank, which is in the authority information obtained from the store-worker master data 308, as authority rank to be assigned to the worker.

Meanwhile, where the attribute determining unit 3002 determines that the user is a worker, who belongs to a store or the like different from the store having the POS terminal 50-to-be-signed-on, the authority rank setting unit 3003 sets authority rank (lower authority rank) lower than the authority rank indicated by the authority information in the worker determination result. By doing so, the authority rank setting unit 3003 entirely or partially restricts the authority of the user (worker), who is specified by the worker code in the sign-on request, and thereby entirely or partially bans execution of the functions of the POS terminal 50. Specifically, the authority rank setting unit 3003 obtains authority information on the basis of the worker determination result. In other words, the authority rank setting unit 3003 obtains the authority information of the user (worker), who is specified by the worker code in the sign-on request, registered in the worker master data 108 by intermediately using the worker determination result. Further, as described above, the authority rank setting unit 3003 sets authority rank lower than the authority rank, which is in the authority information obtained from the worker master data 108, as authority rank to be assigned to the user (worker), who is specified by the worker code in the sign-on request. Note that the authority rank setting unit 3003 may set, as the lower authority rank, authority rank lowered by one grade or authority rank lowered by a plurality of grades.

Note that, where the authority rank of the user (worker) is to be maintained, the authority rank setting unit 3003 sets the authority rank without lowering the authority rank even where the user (worker), who is specified by the worker code in the sign-on request, is a worker, who belongs to a store or the like different from the store of the POS terminal 50-to-be-signed-on. In other words, where the maintaining information of the worker master data 108 obtained by intermediately using the worker determination result indicates that the authority rank is to be maintained, the authority rank setting unit 3003 maintains the authority rank of the worker master data 108.

Further, where the authority rank extracted from the store-worker master data 308 or the worker master data 108 is lower than a threshold, the authority rank setting unit 3003 controls the authority rank so as to avoid setting a lower rank for the authority rank. By doing so, the authority rank setting unit 3003 prevents the authority of the user (worker) from being restricted more than necessary, and prevents a situation, in which work using the POS terminal 50 cannot be executed, from occurring. Note that an arbitrary authority rank may be specified as a threshold.

Where the authority rank setting unit 3003 sets a lower authority rank, the notification control unit 3004 generates notification information for notifying of that fact. Further, the notification control unit 3004 causes the communication control unit 3001 to send the generated notification information to the POS terminal 50-to-be-signed-on. The notification information includes information for informing that execution of a partial function/partial functions is restricted since the authority rank is lowered, and information for informing the lower authority rank. Further, the notification information may include functions unexecutable under the lower authority rank, functions executable under the lower authority rank, and the like.

The authentication result generating unit 3005 generates information to be sent by the communication control unit 3001 as a determination result in response to a sign-on request. Where the attribute determining unit 3002 determines that the user, who is specified by the worker code in the sign-on request, is not a worker, the authentication result generating unit 3005 generates information indicating that sign-on is unpermitted. Further, the authentication result generating unit 3005 causes the communication control unit 3001 to send the information indicating that sign-on is unpermitted as a sign-on result.

Where the attribute determining unit 3002 determines that the user, who is specified by the worker code in the sign-on request, is not a worker, and where the authority rank is not lowered, the authentication result generating unit 3005 generates information indicating that sign-on is permitted. Further, the authentication result generating unit 3005 causes the communication control unit 3001 to send the information indicating that sign-on is permitted and the authority rank set by the authority rank setting unit 3003 as a sign-on result.

Where the attribute determining unit 3002 determines that the user, who is specified by the worker code in the sign-on request, is a worker, and where the authority rank is lowered (changed into lower authority rank), the authentication result generating unit 3005 generates information indicating that sign-on is permitted. Further, the authentication result generating unit 3005 causes the communication control unit 3001 to send, as a sign-on result, the information indicating that sign-on is permitted, the lower authority rank set by the authority rank setting unit 3003, and the notification information generated by the notification control unit 3004.

The controller 501 of the POS terminal 50 loads the control programs 507 stored in the memory device 502 in the RAM, executes the control programs 507, and thereby generates the respective functional units in the RAM. Specifically, the controller 501 of the POS terminal 50 includes, as functional units, the communication control unit 5001, the operation control unit 5002, the sign-on execution unit 5003, the display control unit 5004, and the execution control unit 5005.

The communication control unit 5001 controls the communication interface 503 to communicate with the store servers 30 and the like. For example, the communication control unit 5001 sends a sign-on request, which requests to determine whether sign-on is permitted or not, to the store server 30. Further, the communication control unit 5001 receives a sign-on result from the store server 30.

The operation control unit 5002 controls the operation device 504 to receive operations input by a user. Further, the operation control unit 5002 controls the touch panel layered on the first display device 505 and the touch panel layered on the second display device 506 to receive operations input by a user. For example, the operation control unit 5002 receives operations input by a user to start a function of the POS terminal 50. Further, the operation control unit 5002 receives operations to input a worker code and a password for sign-on. Note that the operation control unit 5002 may not receive a worker code and a password for sign-on to be input. Alternatively, the scanner 509 or the like may read a code symbol or the like to obtain a worker code and a password for sign-on to be input.

The sign-on execution unit 5003 executes sign-on on a basis of a sign-on result from the store server 30. In other words, where sign-on is permitted, the sign-on execution unit 5003 permits use of the POS terminal 50.

The display control unit 5004 controls the first display device 505 and causes the first display device 505 to display various windows. For example, where a sign-on result includes notification information, the display control unit 5004 notifies of that by displaying a notification window on which the notification information is displayed. The notification window contains, for example, a message “Authority rank is lowered. Lower rank is [2]”. By doing so, the notification window notifies a worker, who uses the POS terminal 50, of the fact that the authority rank in the notification information is lowered and the lower authority rank. Further, the message may include the functions unexecutable under the lower authority rank, the functions executable under the lower authority rank, and the like. Note that the display control unit 5004 may cause the first display device 505 to display not only a message but also objects such as icons, values, and the like, and thereby notify of information indicating that the authority rank is lowered and the like. Further, the POS terminal 50 may notify of information indicating that the authority rank is lowered and the like, by using not only the method of displaying on the first display device 505 but also a method of outputting sounds, outputting blinking lights, or the like.

The execution control unit 5005 executes the functions of the POS terminal 50. Where the operation control unit 5002 receives an operation to start a function of the POS terminal 50, the execution control unit 5005 determines whether the user (worker) who inputs the operation has the authority to execute the function or not. In other words, the execution control unit 5005 extracts the authority rank in association with the function code of the function-to-be-started from the execution authority master data 512. Further, where the authority rank of the sign-on user (worker) is equal to or higher than the execution authority rank extracted from the execution authority master data 512, the execution control unit 5005 determines that the sign-on user (worker) has the authority to execute the function. In other words, where the authority rank “value” of the sign-on user (worker) is equal to or less than the execution authority rank “value” extracted from the execution authority master data 512, the execution control unit 5005 determines that the sign-on user (worker) has the authority to execute the function. Further, where the execution control unit 5005 determines that the sign-on user (worker) has the authority to execute the function, the execution control unit 5005 executes the function-to-be-started.

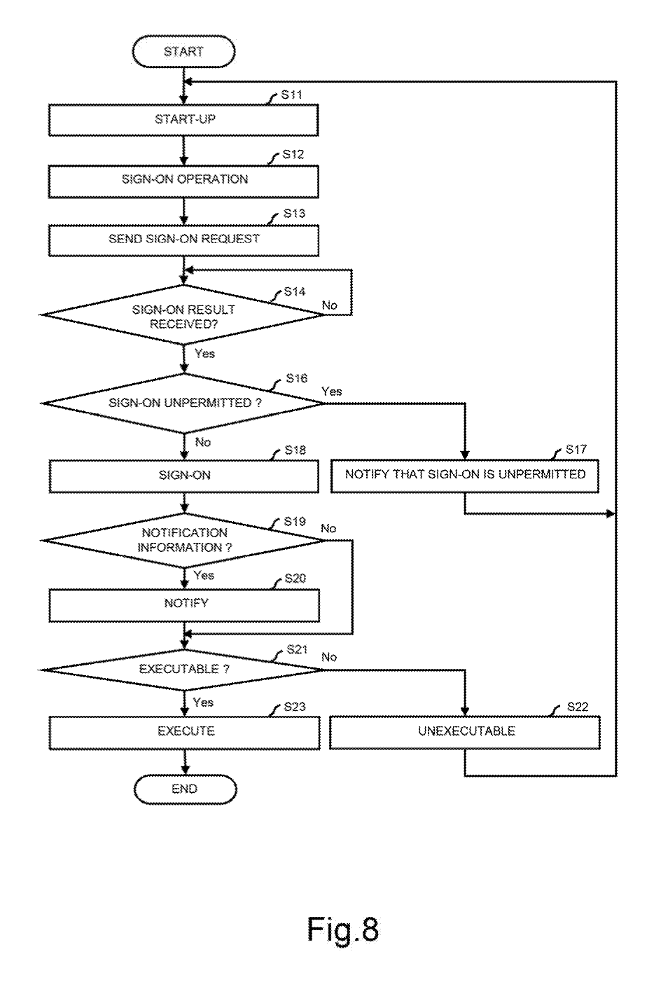

Next, an executing and determining process executed by the POS terminal 50 will be described. Here, FIG. 8 is a flowchart showing an example of an executing and determining process executed by the POS terminal 50 of the present embodiment.

As shown in FIG. 8, in Step S11, the controller 501 (the operation control unit 5002) receives operations to start a function input by a user.

In Step S12, the operation control unit 5002 receives a sign-on operation. In other words, the operation control unit 5002 receives a worker code and a password input by a user.

In Step S13, the controller 501 (the communication control unit 5001) sends a sign-on request to the store server 30. In Step S14, the communication control unit 5001 determines if a sign-on result is received or not. Where a sign-on result is not received (Step S14; No), the communication control unit 5001 stands by until a sign-on result is received.

Meanwhile, where a sign-on result is received (Step S14; Yes), the process of the controller 501 of the POS terminal 50 proceeds to Step S16. In Step S16, the controller 501 (the sign-on execution unit 5003) determines whether the sign-on result includes information indicating that sign-on is unpermitted, or not. Where the sign-on result includes information indicating that sign-on is unpermitted (Step S16; Yes), the process of the controller 501 of the POS terminal 50 proceeds to Step S17. In Step S17, the controller 501 (the display control unit 5004) displays that sign-on is unpermitted.

Meanwhile, where the sign-on result does not include information indicating that sign-on is unpermitted (Step S16; No), the process of the controller 501 of the POS terminal 50 proceeds to Step S18. In Step S18, the controller 501 (the sign-on execution unit 5003) executes sign-on. Specifically, the sign-on execution unit 5003 permits use of the POS terminal 50 by the user who inputs the worker code and the password. In other words, the sign-on execution unit 5003 determines that the user, who inputs the worker code and the password, is a worker who uses the POS terminal 50. So the sign-on execution unit 5003 stores the worker code and the authority rank in the sign-on result in the memory device 502 or the like.

In Step S19, the controller 501 (the display control unit 5004) determines whether the sign-on result includes notification information, which notifies that the authority rank of the user (worker) is lowered, or not. Where the sign-on result includes the notification information (Step S19; Yes), the process of the controller 501 of the POS terminal 50 proceeds to Step S20. In Step S20, the controller 501 (the display control unit 5004) displays a notification window for notification.

Meanwhile, where the sign-on result does not include the notification information (Step S19; No), the process of the controller 501 of the POS terminal 50 proceeds to Step S21.

In Step S21, the controller 501 (the execution control unit 5005) determines whether the function of Step S11 is executable under the authority rank (authority rank in sign-on result) of the user, who inputs the worker code and the password for sign-on, or not. Where the function of Step S11 is unexecutable (Step S21; No), the process of the controller 501 of the POS terminal 50 proceeds to Step S22. In Step S22, the controller 501 (the display control unit 5004) displays a window indicating that the function is unexecutable. Meanwhile, where the function is executable (Step S21; Yes), the process of the controller 501 of the POS terminal 50 proceeds to Step S23. In Step S23, the controller 501 (the execution control unit 5005) executes the function of Step S11.

After that, the POS terminal 50 finishes the executing and determining process.

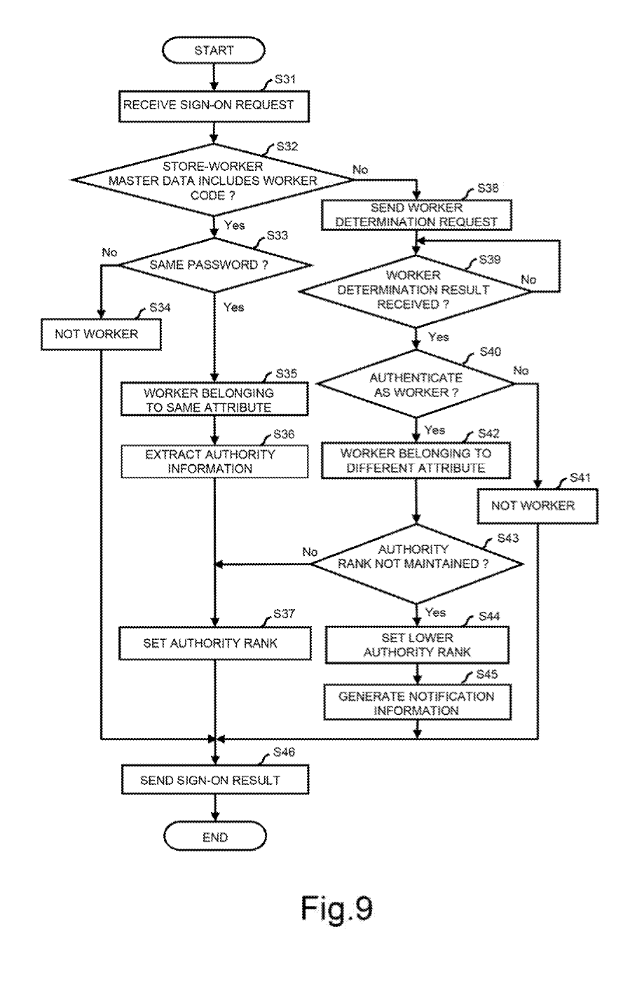

Next, a sign-on process executed by the store server 30 will be described. Here, FIG. 9 is a flowchart showing an example of a sign-on process executed by the store server 30 of the present embodiment.

As shown in FIG. 9, in Step S31, the controller 301 (the communication control unit 3001) receives a sign-on request.

In Step S32, the controller 301 (the attribute determining unit 3002) determines whether the store-worker master data 308 includes the worker code in the sign-on request or not.

Where the store-worker master data 308 includes the worker code (Step S32; Yes), the process of the controller 301 of the store server 30 proceeds to Step S33. In Step S33, the controller 301 (the attribute determining unit 3002) determines whether the password of the store-worker master data 308 is the same as the password in the sign-on request or not.

Where the password of the store-worker master data 308 is different from the password in the sign-on request (Step S33; No), the process of the controller 301 of the store server 30 proceeds to Step S34. In Step S34, the controller 301 (the attribute determining unit 3002) determines that the user is not a worker. Further, the process of the controller 301 of the store server 30 proceeds to Step S46.

Meanwhile, where the password of the store-worker master data 308 is the same as the password in the sign-on request (Step S33; Yes), the process of the controller 301 of the store server 30 proceeds to Step S35. In Step S35, the controller 301 (the attribute determining unit 3002) determines that the user specified by the worker code in the sign-on request is a worker who belong to a store, which is the same as the store having the POS terminal 50-to-be-signed-on.

In Step S36, the controller 301 (the authority rank setting unit 3003) extracts authority information from the store-worker master data 308. In Step S37, the authority rank setting unit 3003 sets the authority rank of the extracted authority information as authority rank, which is to be assigned to a user specified by the worker code in the sign-on request (Step S37). Further, the process of the controller 301 of the store server 30 proceeds to Step S46.

Further, in Step S32, where the store-worker master data 308 does not include the worker code in the sign-on request (Step S32; No), the process of the controller 301 of the store server 30 proceeds to Step S38. In Step S38, the controller 301 (the communication control unit 3001) sends a worker determination request to the headquarter server 10.

In Step S39, the controller 301 (the communication control unit 3001) determines whether a worker determination result is received or not. Where a worker determination result is not received (Step S39; No), the communication control unit 3001 stands by until a worker determination result is received.

Meanwhile, where a worker determination result is received (Step S39; Yes), the process of the controller 301 of the store server 30 proceeds to Step S40. In Step S40, the controller 301 (the attribute determining unit 3002) determines whether the worker determination result includes authenticated information, which authenticates that the user specified by the worker code in the sign-on request is a worker, or not. Where the worker determination result does not include authenticated information (Step S40; No), the process of the controller 301 of the store server 30 proceeds to Step S41. In Step S41, the controller 301 (the attribute determining unit 3002) determines that the user, who is specified by the worker code in the sign-on request, is not a worker.

Meanwhile, where the worker determination result includes authenticated information (Step S40; Yes), the process of the controller 301 of the store server 30 proceeds to Step S42. In Step S42, the controller 301 (the attribute determining unit 3002) determines that the user specified by the worker code in the sign-on request is a worker, who belongs to an attribute different from the attribute to which the POS terminal 50-to-be-signed-on belongs.

In Step S43, the controller 301 (the authority rank setting unit 3003) determines whether the authority rank is to be maintained or not. In other words, the authority rank setting unit 3003 determines whether the worker determination result includes maintaining information, which indicates that the authority rank is to be maintained, or not. Further, the authority rank setting unit 3003 determines whether the authority rank is lower than a threshold or not.

Where the authority rank is to be maintained (Step S43; No), the process of the controller 301 of the store server 30 proceeds to Step S37. In Step S37, the controller 301 (the authority rank setting unit 3003) sets the authority rank in the worker determination result, as authority rank to be assigned to a user specified by the worker code in the sign-on request.

Meanwhile, where the authority rank is not to be maintained (Step S43; Yes), the process of the controller 301 of the store server 30 proceeds to Step S44. In Step S44, the controller 301 (the authority rank setting unit 3003) sets authority rank lower than the authority rank in the worker determination result, as authority rank to be assigned to a user specified by the worker code in the sign-on request.

Next, in Step S45, the controller 301 (the notification control unit 3004) generates notification information.

Further, in Step S46, the controller 301 (the communication control unit 3001) sends a sign-on result to the POS terminal 50.

After that, the store server 30 finishes the sign-on process.

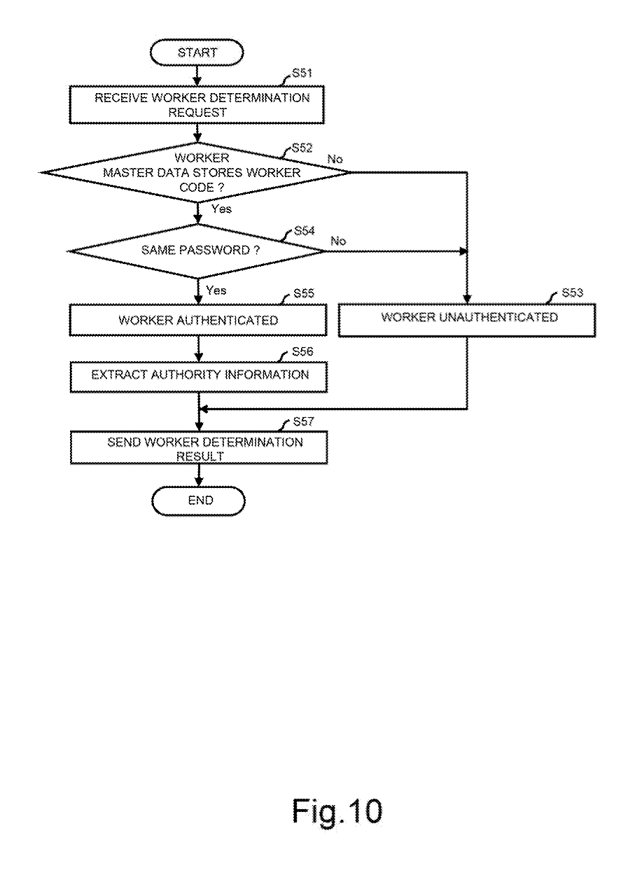

Next, a worker determining process executed by the headquarter server 10 will be described. Here, FIG. 10 is a flowchart showing an example of a worker determining process executed by the headquarter server 10 of the present embodiment.

As shown in FIG. 10, in Step S51, the controller 101 (the communication control unit 1001) receives a worker determination request.

In Step S52, the controller 101 (the worker determining unit 1002) determines whether the worker master data 108 stores the worker code in the worker determination request. Where the worker master data 108 does not store the worker code in the worker determination request (Step S52; No), the process of the controller 101 of the headquarter server 10 proceeds to Step S53. In Step S53, the controller 101 (the worker determining unit 1002) determines that the worker code in the worker determination request is unauthenticated.

Meanwhile, where the worker master data 108 stores the worker code (Step S52; Yes), the process of the controller 101 of the headquarter server 10 proceeds to Step S54. In Step S54, the controller 101 (the worker determining unit 1002) determines whether the password of the worker master data 108 is the same as the password in the worker determination request or not. Where the password of the worker master data 108 is different from the password in the worker determination request (Step S54; No), the process of the controller 101 of the headquarter server 10 proceeds to Step S53. In Step S53, the controller 101 (the attribute determining unit 3002) determines that the worker is unauthenticated.

Meanwhile, where the password of the worker master data 108 is the same as the password in the worker determination request (Step S54; Yes), the process of the controller 101 of the headquarter server 10 proceeds to Step S55. In Step S55, the controller 101 (the worker determining unit 1002) authenticates that the user is a worker. Next, in Step S56, the controller 101 (the determination result generating unit 1003) extracts authority information in association with the combination of a worker code and a password from the worker master data 108.

Next, in Step S57, the controller 101 (the communication control unit 1001) sends a worker determination result to the POS terminal 50.

After that, the headquarter server 10 finishes the worker determining process.

As described above, according to the store server 30 of the present embodiment, the controller 301 (the attribute determining unit 3002) determines whether the attribute to which a worker, who requests sign-on, belongs is different from the attribute to which the POS terminal 50-to-be-signed-on belongs or not. Further, where the attribute to which the worker belongs is different from the attribute to which the POS terminal 50 belongs, the controller 301 (the authority rank setting unit 3003) assigns lower authority rank. As a result, the controller 301 (the authority rank setting unit 3003) assigns authority, in which execution of a partial function/partial functions out of the functions of the POS terminal 50 is restricted, to the worker. Therefore, the store server 30 is capable of assigning appropriate authority for operation or use of the POS terminal 50 to a user on the basis of a relation between the POS terminal 50 and a user of the POS terminal 50.

In the above-mentioned embodiment, the store server 30 stores the store-worker master data 308, in which information of a worker who belongs to a store is registered. However, the present embodiment is not limited to this. For example, the store server 30 may store the worker master data 108. In this case, the controller 301 (the attribute determining unit 3002) extracts the attribute code in association with a worker code, which is the same the worker code in the sign-on request, from the worker master data 108. Further, the attribute determining unit 3002 compares the extracted attribute code with the attribute code stored in the attribute code storage area 309. Where the extracted attribute code is the same as the attribute code stored in the attribute code storage area 309, the attribute determining unit 3002 determines that the user is a worker who belongs to a store, which is the same as a store to which the POS terminal 50-to-be-signed-on belongs. Where the extracted attribute code is different from the attribute code stored in the attribute code storage area 309, the attribute determining unit 3002 determines that the user is a worker who belongs to a store or the like, which is different from a store to which the POS terminal 50-to-be-signed-on belongs.

Further, in the example of the above-mentioned embodiment, the store server 30 is an information processing apparatus. However, the present embodiment is not limited to this. For example, the headquarter server 10 or the POS terminal 50 may be an information processing apparatus. In other words, the headquarter server 10, the POS terminal 50, or another apparatus may entirely or partially include the functions of the store server 30. Further, for example, a worker ID card may store information of any one of only a worker code of the worker, a combination of a worker code and attribute information of the worker, a combination of a worker code and authority rank assigned to the worker, a combination of attribute information of the worker and authority rank, and a combination of a worker code, information of the worker, and authority rank. The POS terminal 50 may include an interface for obtaining necessary information from the worker ID card. Where it is possible to obtain the attribute information and the authority rank of the worker from the worker ID card, the POS terminal 50 may prestore attribute information of the attribute to which the POS terminal 50 belongs. For example, the POS terminal 50 may determine whether the attribute information of the worker obtained from the worker ID card is the same as the attribute information of the POS terminal 50 or not. The POS terminal 50 may select one of to use the authority rank obtained from the worker ID card as it is or to change the authority rank on the basis of the determination result. Where it is possible to obtain a worker code and authority rank assigned to the worker from a worker ID card, the POS terminal 50 stores and holds the worker code of each worker who belongs to the store, to which the POS terminal 50 belongs. The POS terminal 50 determines whether the worker code obtained from the worker ID card is the same as the worker code of a worker who belongs to the store, which the POS terminal 50 stores and holds, or not. The POS terminal 50 may select one of to use the authority rank obtained from the worker ID card as it is and to change the authority rank on the basis of the determination result.

Each program executed by each apparatus of the present embodiment and modification examples is preinstalled in the storage medium (ROM or memory device) of each apparatus and provided. Not limited to this, for example, each of the above-mentioned programs may be recorded in an installable format file or an executable format file in a computer readable recording medium such as a CD-ROM, a flexible disk (FD), a CD-R, and a DVD (Digital Versatile Disk) and provided. Further, the storage medium is not limited to a medium independent of a computer or an embedded system. The storage medium includes a storage medium, which stores or temporarily stores a program transmitted via a LAN, the Internet, or the like and downloaded.

Further, each program executed by each apparatus of the present embodiment and modification examples may be stored in a computer connected to a network such as the Internet, downloaded via the network, and provided. Alternatively, each program may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus that manages an information processing terminal, the information processing terminal belonging to a predetermined department and being configured to execute a plurality of functions, the information processing apparatus comprising:
a communication interface configured to communicate with the information processing terminal and a different information processing apparatus;
a memory device that stores master data of a special user, use of the information processing terminal being permitted for the special user, the master data including identifier information identifying the special user and authority information preregistered in association with each other, the authority information indicating authority of execution of the plurality of functions of the information processing terminal; and
a controller configured to
input an authentication request for a user from the information processing terminal via the communication interface, the authentication request including identifier information identifying a user who wishes to use the information processing terminal,
determine that the user identified by the identifier information in the authentication request is the special user on a basis of the identifier information in the authentication request and the identifier information registered in the master data of the special user,
obtain the authority information of the determined special user from the master data of the special user, and
where a department to which the determined special user belongs is different from a department to which the information processing terminal belongs, in order to restrict execution of a partial function/partial functions out of executable functions of the information processing terminal, the executable functions being executable based on authority indicated by the obtained authority information,
change the obtained authority information into authority information indicating a lower authority, and
set the changed authority information as authority information of the user identified by the identifier information in the authentication request.

2. The information processing apparatus according to claim 1, wherein
the controller is further configured to
where the identifier information identifying a user in the authentication request is registered in the master data of the special user, determine that the user identified by the identifier information in the authentication request is the special user and that a department to which the special user belongs is the same as a department to which the information processing terminal belongs, and
where the identifier information identifying a user in the authentication request is not registered in the master data of the special user,
input a determination result from the different information processing apparatus via the communication interface, the determination result indicating that the user identified by the identifier information in the authentication request is the special user, and
determine, on a basis of the input determination result, that the user identified by the identifier information in the authentication request is the special user and that a department to which the special user belongs is different from a department to which the information processing terminal belongs.

3. The information processing apparatus according to claim 1, wherein
the controller is further configured to generate, where the controller sets the changed authority information as the authority information of the user identified by the identifier information in the authentication request, an authentication result including notification information, the notification information indicating that the authority information of the user identified by the identifier information in the authentication request is changed, and
the communication interface outputs, in response to the authentication request, the authentication result including the notification information to the information processing terminal.

4. The information processing apparatus according to claim 2, wherein
the controller is further configured to generate an authentication result including notification information, the notification information notifying that execution of the partial function/partial functions of the information processing terminal is restricted.

5. The information processing apparatus according to claim 1, wherein
the controller is further configured to maintain the authority indicated by the obtained authority information without changing the authority, even where the department, to which the user identified by the identifier information in the authentication request belongs, is different from the department to which the information processing terminal belongs, on a condition that the authority information obtained from the master data of the special user includes maintaining information, the maintaining information indicating that execution of the functions of the information processing terminal is not restricted but maintained.

6. The information processing apparatus according to claim 1, wherein
the controller is further configured to generate, where the user identified by the identifier information in the authentication request is the special user and where a department to which the special user belongs is the same as a department to which the information processing terminal belongs, an authentication result in response to the authentication request, the authentication result including the authority information obtained from the master data of the special user.

7. The information processing apparatus according to claim 6, wherein
the controller is further configured to generate, where the user identified by the identifier information in the authentication request is the special user and where a department to which the special user belongs is different from a department to which the information processing terminal belongs, an authentication result in response to the authentication request, the authentication result including the changed authority information.

8. The information processing apparatus according to claim 1, wherein
the authority information includes authority rank, the authority rank indicating the authority and being set graded, and
the controller is further configured to restrict execution of the partial function/partial functions of the information processing terminal by setting a lower rank for the authority rank.

9. The information processing apparatus according to claim 8, wherein
the controller is further configured to avoid setting a lower rank for the authority rank, even where the department to which the special user belongs is different from the department to which the information processing terminal belongs, on a condition that the authority rank in the authority information is lower than a threshold.

10. An information processing method executed by an information processing apparatus including
a communication interface configured to communicate with an information processing terminal and a different information processing apparatus, the information processing terminal belonging to a predetermined department and being configured to execute a plurality of functions, and
a memory device that stores master data of a special user, the master data including authority information preregistered, the authority information indicating authority of execution of the plurality of functions of the information processing terminal,
the information processing method comprising:
inputting an authentication request for a user from the information processing terminal via the communication interface, the authentication request including identifier information identifying a user who wishes to use the information processing terminal;
determining that the user identified by the identifier information in the authentication request is the special user on a basis of the identifier information in the authentication request and the identifier information registered in the master data of the special user;
obtaining the authority information of the determined special user from the master data of the special user; and
where a department to which the determined special user belongs is different from a department to which the information processing terminal belongs, in order to restrict execution of a partial function/partial functions out of executable functions of the information processing terminal, the executable functions being executable based on authority indicated by the obtained authority information,
changing the obtained authority information into authority information indicating a lower authority, and
setting the changed authority information as authority information of the user identified by the identifier information in the authentication request.
